(19) United States
(12) Patent Application Publication
(10) Pub. No.: US 2014/0269410 A1
(43) Pub. Date: Sep. 18, 2014

(54) Efficient Flooding of Link State Packets for Layer 2 Link State Protocols

(71) Applicant: CISCO TECHNOLOGY, INC., San Jose, CA (US)

(72) Inventors: Varun Shah, Milpitas, CA (US); Ayan Banerjee, Fremont, CA (US); Dhananjaya Rao, Milpitas, CA (US); Raghava Sivaramu, Sunnyvale, CA (US); Abhay Roy, Cupertino, CA (US)

(73) Assignee: CISCO TECHNOLOGY, INC., San Jose, CA (US)

(21) Appl. No.: 13/826,572

(22) Filed: Mar. 14, 2013

(51) Int. Cl. H04L 12/24; H04L 12/721

(52) U.S. Cl. CPC H04L 41/12; H04L 45/12
USPC 370/254

(57) ABSTRACT

Techniques are provided for generating and updating flooding tree paths in a network. At a particular node device in a network, a first flooding tree is generated by performing a first shortest path first (SPF) operation from a first selected node device in the network to a plurality of other node devices in the network. A second flooding tree is generated by performing a second SPF operation from a second selected node device in the network to the plurality of other node devices in the network. A network topology change event is detected in either the first or second flooding tree, and a packet sequence exchange is initiated between the particular node device and another node device in the network in response to the detected network topology change. The first and second flooding trees are then updated based on information obtained during the packet sequence exchange.

### TECHNICAL FIELD

The present disclosure relates to ensuring efficient distribution of packets in a network.

### BACKGROUND

Link state packets (LSPs) are generated by a network router or node and are distributed in a network to propagate link state information associated with the network router. These LSPs are distributed hop-by-hop within a network such that the LSPs are sent from a network node to every adjacent neighbor node in the network. The techniques for distributing the LSPs hop-by-hop have scalability limits, as the LSP message distribution techniques within the network are inefficient and redundant. For example, in meshed network topologies, redundant network flooding is commonplace, which reduces the scalability of those networks.

### BRIEF DESCRIPTION OF THE DRAWINGS

FIG. 1 shows an example network including a plurality of network nodes and a plurality of flooding tree paths used to distribute packets efficiently in the network.

FIGS. 2A and 2B illustrate example fields of a node identifier database accessible by the network node to identify selected nodes in the network as a root flooding tree nodes for the flooding tree paths.

FIG. 3 shows an example flow chart depicting operations performed by the network nodes to distribute flooding tree updates to network nodes.

FIG. 4 shows an example flow chart depicting operations performed by one or more of the network nodes to select root flooding tree nodes and to generate and update the flooding tree paths in the network.

FIG. 5 shows an example block diagram of a network node configured to generate and update the flooding tree paths in the network.

### DESCRIPTION OF EXAMPLE EMBODIMENTS

### Overview

Techniques are provided for generating and updating flooding tree paths in a network. At a particular node device in a network, a first flooding tree is generated by performing a first shortest path first operation from a first selected node device in the network to a plurality of other node devices in the network. A second flooding tree is generated by performing a second shortest path first operation from a second selected node device in the network to the plurality of other node devices in the network. A network topology change event is detected in either the first flooding tree or the second flooding tree, and a packet sequence exchange is initiated between the particular node device and another node device in the network in response to the detected network topology change. The first flooding tree and the second flooding tree are then updated based on information obtained during the packet sequence exchange.

### Example Embodiments

The techniques described herein relate to generating flooding tree communication paths within a network and updating the flooding tree communication paths in response to network disruption events. One or more network nodes within the network may perform these techniques. An example system/topology 100 is illustrated in FIG. 1. The topology 100 (hereinafter “network topology” or “network”) comprises a plurality of network node devices (hereinafter “network nodes” or “nodes”) 102(1)-102(n) (also referred to as “node 1”-“node N,” respectively). The network nodes 102(1)-102(n) are connected to one another across one or more network links. For example, in a fully meshed network, each of the network nodes is connected to every other network node across a corresponding network link. In another example, in a partially meshed network, each of the network nodes may be connected to one or more, but not all, of the other network nodes. An example network link is shown in FIG. 1 between node 1 and node N, but it should be appreciated that network links may be present between any of the nodes. It should also be appreciated that network 100 may be any network topology comprising a plurality of network nodes (e.g., a fully-meshed network, a partially-meshed network, a ring network topology, etc.).

Packets may be sent along one or more of the network links to the nodes 102(1)-102(n). These packets may be link state packets (LSPs), broadcast packets, etc. Often, packets may be broadcast to all of the nodes 102(1)-102(n) in the network 100. For example, information pertaining to network updates, administration and topology/architecture, etc., may need to be distributed to all of the nodes 102(1)-102(n). According to the techniques presented herein, multiple flooding tree paths (“flooding trees”) in the network 100 may be generated by one or more of the nodes 102(1)-102(n) to ensure that packets with such information are able to reach all of the nodes in the network 100 efficiently. For example, as shown in FIG. 1, one of the nodes 102(1)-102(n), e.g., node 102(3), may be selected as a root node for a first flooding tree (shown as “flooding tree A” in FIG. 1). Additionally, another one of the nodes 102(1)-102(n), e.g., node 102(1), may be selected as a root node for a second flooding tree (shown as “flooding tree B” in FIG. 1). In one example, flooding tree A and flooding tree B may also share the same root node.

FIG. 1 shows flooding tree network links for flooding tree A and flooding tree B. As described above, FIG. 1 shows a non-flooding tree network link between node 1 and node N. The flooding tree network links and non-flooding tree network links may be similar to each other. For example, the network links may be Ethernet or other network links capable of sending and receiving data packets to and from network nodes. The classification of a network link as a flooding tree network link or a non-flooding tree network link is performed by one or more of the nodes 102(1)-102(n) as part of a process for generating and updating the flooding trees.

One or more of the nodes 102(1)-102(n) may be identified as root nodes for corresponding flooding trees in the network 100. Flooding tree A and flooding tree B in the network 100 allow for efficient routing of packets within the network 100. In other words, packets that are intended to be distributed to all nodes 102(1)-102(n) can traverse the network 100 along the generated flooding trees to ensure that each node receives the packet without traversing unnecessary or redundant network links. The presence of multiple flooding trees in the network 100 ensures that LSPs and/or broadcast packets will be distributed to every node in a network, even in the event of a failure or disruption in one of the flooding trees (e.g., a “network topology change event”). That is, if there is a failure or disruption event (e.g., a node removal or link failure) in flooding tree A, LSPs and broadcast packets can still be distributed to the nodes 102(1)-102(n) via flooding tree B. Likewise, if there is a failure or disruption event in flooding tree B, LSPs and broadcast packets can still be distributed to the nodes 102(1)-102(n) via flooding tree A.

The techniques herein describe generating and updating the multiple flooding trees to ensure this network redundancy for LSPs and broadcast packets. In particular, the multiple flooding trees are generated to ensure that the flooding trees minimize the number of common network links. Instead, flooding tree A and flooding tree B are generated by using the maximum disjoint set of network links. For example, the disjoint sets may be produced by ensuring that a parent link selection algorithm for flooding tree B is based on a lower extended circuit identifier (circuit ID) as opposed to the higher circuit ID for flooding tree A. Flooding tree A and flooding tree B may efficiently route packets to all nodes in the network. The flooding trees described herein may be shared trees that span all of the nodes in a network. In one example, the flooding trees are broadcast trees, for example, in accordance with Cisco Systems' FabricPath network topologies.

In order to select the flooding tree paths in the network 100, each of the nodes 102(1)-102(n) is configured to gather and access node connectivity information associated with every other node in the network 100 (e.g., from a node identifier database accessible by the nodes 102(1)-102(n)). Based on the node connectivity information, the nodes 102(1)-102(n) can determine which node to classify or select as a root node for the flooding trees. After determining the root node for the flooding trees, the nodes 102(1)-102(n) can determine the flooding tree paths by performing a shortest path first (SPF) operation from the root flooding tree node to the plurality of node devices in the network. In one example, the flooding trees can be generated using a Transport Interconnect with Lots of Links (TRILL) protocol such that relatively high priority network links are used for flooding tree A and relatively low priority links are used for flooding tree B, in order to further ensure a maximum number of disjoint links between flooding tree A and flooding tree B.

As stated above, flooding tree A and flooding tree B may be modified and updated in response to a network topology event. For example, in the event of a network node being removed from one or more of the flooding trees, LSPs and broadcast packets continue to be flooded on remaining portions of the flooding tree. For example, a root node may be removed due to a node reload/reboot or a link failure. This may result in local triggers on nodes that neighbor the root node, and as a result, the neighboring nodes will attempt to flood packets to a sub-network that does not traverse through the root node. Meanwhile, a new root node will be re-elected, and since the flooding tree for the new neighboring nodes of the new root node has changed, these neighboring nodes will send a complete sequence number protocol data unit (CSNP) on the new flood tree links. This will cause any disjointed sets for nodes to receive a new copy of the LSPs that it may have missed due to the removal of the original root node.

If the removed node rejoins its corresponding flooding tree, LSPs and broadcast packets are distributed from one or more other nodes in the flooding tree to the rejoined network node. In the event of network changes that are local to a network node (e.g., a root priority change, a change to a metric of a link, etc.) the LSPs may be flooded on the union of network links that comprise flooding tree A and flooding tree B.

In another example, in the event of a new node joining a network (that has a corresponding new network link to one or more of the nodes 102(1)-102(n)), a packet sequence exchange occurs between one of the node devices (a “particular node” or “existing node”) in flooding tree A and/or flooding tree B and the new node (also referred to as “another node”). For example, in FIG. 1, the particular node may be node 1 in FIG. 1, and the new node may be node N in FIG. 1. The packet sequence exchange involves node 1 sending information contained in headers of LSPs to node N. For example, the information in the headers may be a CSNP. The headers of the LSPs contain routing information associated with all of the nodes in the network. Upon receiving these headers, node N evaluates the header and determines that it does not have the routing information associated with the nodes listed in the header (e.g., node 2 to node 6 in the network 100). As a result, node N initiates a packet sequence exchange by sending a request message to node 1 for the routing information associated with the nodes listed in the headers. This request message may be a partial sequence number protocol data unit (PSNP) message. Node 1 responds with a packet sequence response by sending a response message to node N with the routing information requested by node N. This response message may be a CSNP message. Thus, the packet sequence exchange between node 1 and node N may be referred to as a CSNP/PSNP exchange. After node 1 sends the routing information of the nodes in the network 100 to node N, node 1 (or any other node in the network) can update flooding tree A and flooding tree B to include node N and the network links associated with node N by using the tree generation techniques described above (e.g., by performing an SPF operation). In one example, the nodes that are designated as root nodes of the flooding trees after the update determine the priority information of the network link associated with the new node, and the flooding tree is updated to include the new network link if it has a higher priority than other network links. For example, if the new network link has a higher priority than other network links in flooding tree A, the new network link is included in the update to flooding tree A. Likewise, if the new network link has a higher priority than other network links in flooding tree B, the new network link is included in the update to flooding tree B. For example, for flooding tree B, a link with a lower priority may be selected as a part of the flooding tree in order to ensure that flooding tree A and flooding tree B have the maximum disjoint set. In one example, links may be included in flooding tree A that have a higher priority than links on flooding tree B.

Reference is now made to FIGS. 2A and 2B. FIGS. 2A and 2B show a node identifier database 200 that stores node connectivity information for the flooding trees. For example, FIG. 2A shows the node connectivity information for flooding tree A, and FIG. 2B shows the node connectivity information for flooding tree B. The node identifier database 200 may be stored in memory of each of the nodes 102(1)-102(n) (as described hereinafter) or may be stored remotely such that each of the nodes 102(1)-102(n) is able to access the contents of the database 200. Additionally, each of the nodes 102(1)-102(n) is able to update the database 200 with node connectivity information as the network topology changes. For example, if the topology of network 100 changes, each of the nodes 102(1)-102(n) can update the node connectivity information in the database 200 to reflect the change in network topology.

As shown in FIG. 1, each of the nodes 102(1)-102(n) may announce its priority value to become a root node for a particular flooding tree. The node with the highest priority value is used to determine the root nodes of flooding tree A and flooding tree B. In the case of a tie (e.g., when a there are two or more nodes with the highest priority value), the tie is resolved by utilizing higher system-identifiers, a higher nickname classification or switch identifier associated with a particular node. For example, as shown in FIGS. 1 and FIGS. 2A and 2B, node 3 is selected as the root node for flooding tree A, and node 1 is selected as the root node for flooding tree B. Thus, after node 3 is selected as the root node for flooding tree A and node 1 is selected as the root node for flooding tree B, a shortest path tree algorithm is applied to determine the SPF originating from node 3 and node 1 and reaching all of the nodes in the network. This SPF defines flooding tree A and flooding tree B, respectively, in the network. In FIG. 1, for example, the SPF from node 3 is defined as follows:

Node 3-Node 4

Node 3-Node 6-Node 5

Node 3-Node 6-Node 1-Node 2

Thus, the flooding tree path for flooding tree A originates from node 3 and the path reaches each of the nodes in the network by following the SPF path described above. Likewise, in FIG. 1, the SPF from node 1 is defined as follows:

Node 1-Node 2

Node 1-Node 4-Node 3

Node 1-Node 4-Node 5-Node 6

Thus, the flooding tree path for flooding tree A originates from node 1 and the path reaches each of the nodes in the network by following the SPF path described above.

If a packet is to be distributed to all nodes in the network (e.g., link state packets, broadcast packets, etc.), the packet can traverse the flooding trees described above to reach all of the nodes in the network 100 without any redundant packet distribution to network nodes. In other words, packets can be sent to all nodes in the network across the flooding tree paths using a number of network links in the network 100 less than that which would be used without the flooding tree.

In the event of one or more link failures or other network disruption events in the network 100, the flooding trees can be updated to enable network connections to node devices associated with the network disruption event. For example, if a non-flooding tree network link is removed from the network 100, the flooding tree paths may not be altered since packet flooding may still occur to network nodes over the flooding trees even with the removal of the non-flooding tree network link. If, however, a flooding tree network link is removed from the network 100, flooding packets may be distributed along the flooding tree path up until the removed network link. When a packet cannot further traverse the original flooding tree (due to the removed link), the last node to receive the packet will perform a new SPF operation to determine the SPF path to the remaining nodes in the network 100. Thus, in response to the removal of a flooding tree network link, each flooding tree will be divided into two (or more) flooding sub-trees in network 100: the first flooding sub-tree defined as the original flooding tree up until the removed link, and the second flooding sub-tree defined as the new SPF from the last node receiving the packet in the first flooding sub-tree to the remaining nodes in the network. In other words, the last node receiving the packet in the first flooding sub-tree will be classified as a new root node of the new flooding sub-tree and a new flooding sub-tree will be generated by performing a new SPF operation from this new root node.

In response to a network link addition (due to the addition of a new network node (e.g., node N) in the network), the flooding trees can be updated by using the CSNP/PSNP packet exchange between any node in the existing flooding trees and the new node. In one example, the CSNP/PSNP exchange to update flooding tree A occurs between node 3 and node N, and the CSNP/PSNP exchange to update flooding tree B occurs between node 1 and node N.

Reference is now made to FIG. 3. FIG. 3 shows an example flow chart 300 that depicts operations performed by network nodes to distribute flooding tree updates to network nodes. At operation 305, a presence of a network node joining the network is detected. At operation 310, a first flooding tree is calculated with a first root node, and at operation 315, a second flooding tree is calculated with a second root node. It should be appreciated that, in one example, until the first flooding tree and the second flooding tree are calculated, standard flooding principles are followed until a network node is included in one of the flooding trees. This is to avoid a bootstrap problem where network communications may be disrupted or may not reach every node in the network due to the absence of a flooding tree being generated. The first flooding tree and the second flooding tree may comprise, for example, a maximally disjoint set of network nodes in the network. At operation 320, a new LSP packet is generated at a network node, and at operation 325, the new LSP packet is flooded on the first flooding tree and the second flooding tree. If a network trigger event (e.g., a link shutdown) causes a new flooding tree to be generated, a CSNP exchange is performed at operation 330 to update other network nodes if a LSP packet has not been received by the other network nodes.

Reference is now made to FIG. 4. FIG. 4 shows a flow chart 400 involving operations utilized by one or more of the nodes 102(1)-102(n) to select root nodes for flooding trees and to update the flooding trees in response to a network topology change event. At operation 410, a particular node device in the network generates a first flooding tree by performing a first shortest path operation from a first selected node device in the network to a plurality of other node devices in the network. At operation 415, a second flooding tree is generated by performing a second shortest path first operation from a second selected node device in the network to a plurality of other node devices in the network. At operation 420, a network topology change event is detected in either the first flooding tree or the second flooding tree, and at operation 425, a packet sequence exchange is initiated between the particular node device and another node device (e.g., a new node device) in the network in response to the detecting. At operation 430, the first flooding tree and the second flooding tree are updated based on information obtained during the packet sequence exchange.

Reference is now made to FIG. 5. FIG. 5 shows an example block diagram of one of the nodes 102(1)-102(n). The block diagram is depicted generally as a network node device at reference numeral 102, though it should be appreciated that this diagram may represent any of the nodes 102(1)-102(n). The network node device 102 comprises, among other components, a plurality of ports 502, a switch unit 504, a processor 506 and a memory 508. The ports 502 are configured to receive communications (e.g., data packets) sent in the network 100 from other node devices and to send communications in the network 100 to the other node devices across one or more network links. The ports 502 are coupled to a switch unit 504. The switch unit 504 is configured to perform packet switching/forwarding operations on packets received from other network nodes in the network 100. Additionally, the switch unit 504 is configured to select a network node in the network 100 to operate as root nodes for a flooding tree generated by the network node 102. The switch unit 504 may be embodied in one or more application specific integrated circuits.

The switch unit 504 is coupled to the processor 506. The processor 506 is, for example, a microprocessor or microcontroller that is configured to execute program logic instructions (i.e., software) for carrying out various operations and tasks of the network node 102, as described herein. For example, the processor 506 is configured to execute flooding tree selection process logic 510 to generate and update flooding trees in the network 100. The functions of the processor 506 may be implemented by logic encoded in one or more tangible computer readable storage media or devices (e.g., storage devices compact discs, digital video discs, flash memory drives, etc. and embedded logic such as an application specific integrated circuit, digital signal processor instructions, software that is executed by a processor, etc.).

The memory 508 may comprise read only memory (ROM), random access memory (RAM), magnetic disk storage media devices, optical storage media devices, flash memory devices, electrical, optical, or other physical/tangible (non-transitory) memory storage devices. The memory 508 stores software instructions for the flooding tree selection process logic 510. The memory 508 may also host a node identifier database (“database”) 200 that stores, for example, node connectivity information for nodes in flooding tree A and flooding tree B in the network 100. Thus, in general, the memory 506 may comprise one or more computer readable storage media (e.g., a memory storage device) encoded with software comprising computer executable instructions and when the software is executed (e.g., by the processor 506) it is operable to perform the operations described for the flooding tree selection process logic 510.

The flooding tree selection process logic 510 may take any of a variety of forms, so as to be encoded in one or more tangible computer readable memory media or storage device for execution, such as fixed logic or programmable logic (e.g., software/computer instructions executed by a processor), and the processor 506 may be an application specific integrated circuit (ASIC) that comprises fixed digital logic, or a combination thereof.

In still another example, the processor 506 may be embodied by digital logic gates in a fixed or programmable digital logic integrated circuit, which digital logic gates are configured to perform the flooding tree selection process logic 510. In general, the flooding tree selection process logic 510 may be embodied in one or more computer readable storage media encoded with software comprising computer executable instructions and when the software is executed operable to perform the operations described above.

It should be appreciated that the techniques described above in connection with all embodiments may be performed by one or more computer readable storage media that is encoded with software comprising computer executable instructions to perform the methods and steps described herein. For example, the operations performed by one or more of the network nodes 102(1)-102(n) may be performed by one or more computer or machine readable storage media (non-transitory) or device executed by a processor and comprising software, hardware or a combination of software and hardware to perform the techniques described herein.

In summary, a method is provided involving a particular node device in a network generating a first flooding tree by performing a first shortest path first operation from a first selected node device in the network to a plurality of other node devices in the network; generating a second flooding tree by performing a second shortest path first operation from a second selected node device in the network to the plurality of other node devices in the network; detecting a network topology change event in either the first flooding tree or the second flooding tree; initiating a packet sequence exchange between the particular node device and another node device in the network in response to the detecting; and updating the first flooding tree and the second flooding tree based on information obtained during the packet sequence exchange.

Additionally, an apparatus is provided comprising: a plurality of ports configured to receive packets from and send packets to a network; a switch unit coupled to the plurality of ports; a memory; and a processor coupled to the switch unit and the memory and configured to: generate a first flooding tree by performing a first shortest path first operation from a first selected node device in the network to a plurality of other node devices in a network; generate a second flooding tree by performing a second shortest path first operation from a second selected node device in the network to the plurality of other node devices in the network; detect a network topology change event in either the first flooding tree or the second flooding tree; initiate a packet sequence exchange between a particular node device and another node device in the network in response to the detecting; and update the first flooding tree and the second flooding tree based on information obtained during the packet sequence exchange.

In addition, one or more computer readable storage media encoded with software is provided comprising computer executable instructions and when the software is executed operable to: generate a first flooding tree by performing a first shortest path first operation from a first selected node device in the network to a plurality of other node devices in a network; generate a second flooding tree by performing a second shortest path first operation from a second selected node device in the network to the plurality of other node devices in the network; detect a network topology change event in either the first flooding tree or the second flooding tree; initiate a packet sequence exchange between a particular node device and another node device in the network in response to the detecting; and update the first flooding tree and the second flooding tree based on information obtained during the packet sequence exchange.

The above description is intended by way of example only. Various modifications and structural changes may be made therein without departing from the scope of the concepts described herein and within the scope and range of equivalents of the claims.

What is claimed is:

1. A method comprising:
at a particular node device in a network, generating a first flooding tree by performing a first shortest path first operation from a first selected node device in the network to a plurality of other node devices in the network;
generating a second flooding tree by performing a second shortest path first operation from a second selected node device in the network to the plurality of other node devices in the network;
detecting a network topology change event in either the first flooding tree or the second flooding tree;
initiating a packet sequence exchange between the particular node device and another node device in the network in response to the detecting; and
updating the first flooding tree and the second flooding tree based on information obtained during the packet sequence exchange.

2. The method of claim 1, wherein initiating comprises initiating the packet sequence exchange when the network topology change event involves a new node device being added to the network, wherein the packet sequence exchange occurs between the node device and the new node device.

3. The method of claim 2, further comprising:
sending information contained in headers of link state packets (LSPs) associated with all of the plurality of node devices from the particular node device to the new node device as a part of the packet sequence exchange;
receiving a request from the new node device for the LSPs of one or more of the plurality of node devices;
sending the LSPs to the new node device in response to receiving the request; and
updating the first flooding tree and the second flooding tree to include the new node device.

4. The method of claim 1, wherein initiating comprises initiating the packet sequence exchange when the network topology change involves a new network link being added to the network, wherein the packet sequence exchange occurs between the particular node device and one or more node devices associated with the new network link.

5. The method of claim 4, further comprising:
sending headers of link state packets link state packets associated with all of the plurality of node devices to the one or more node devices associated with the new network link;
receiving a request from the one or more of the node devices associated with the new network link for the link state packets of one or more of the plurality of node devices; and
sending the link state packets to the one or more of the node devices associated with the new network link in response to receiving the request.

6. The method of claim 4, further comprising:
determining priority information of the new network link;
updating the first flooding tree to include the new network link if the priority information of the new network link indicates that the new network link has a higher priority than other network links in the first flooding tree; and
updating the second flooding tree to include the new network link if the priority information of the new network link indicates that the new network link has a higher priority than other network links in the second flooding tree.

7. The method of claim 1, wherein initiating the packet sequence exchange comprises initiating the packet sequence exchange that involves a complete sequence number protocol data unit exchange from the particular node device to the another node device and that involves a partial sequence number protocol data unit exchange from the another node device to the node device.

8. The method of claim 1, wherein generating the first flooding tree and the second flooding tree comprises generating the first flooding tree and the second flooding tree such the first flooding tree and the second flooding tree have a maximum disjoint number of network links.

9. The method of claim 1, wherein generating the first flooding tree comprises generating the first flooding tree using a Transport Interconnect with Lots of Links (TRILL) protocol such that relative high priority network links are used for the first flooding tree, and wherein generating the second flooding tree comprises generating the second flooding tree using the TRILL protocol such that relatively low priority network links are used for the second flooding tree.

10. An apparatus comprising:
a plurality of ports configured to receive packets from and send packets to a network;
a switch unit coupled to the plurality of ports;
a memory; and
a processor coupled to the switch unit and the memory and configured to:
generate a first flooding tree by performing a first shortest path first operation from a first selected node device in the network to a plurality of other node devices in a network;
generate a second flooding tree by performing a second shortest path first operation from a second selected node device in the network to the plurality of other node devices in the network;
detect a network topology change event in either the first flooding tree or the second flooding tree;
initiate a packet sequence exchange between a particular node device and another node device in the network in response to the detecting; and
update the first flooding tree and the second flooding tree based on information obtained during the packet sequence exchange.

11. The apparatus of claim 10, wherein the processor is further configured to initiate the packet sequence exchange when the network topology change event involves a new node device being added to the network, wherein the packet sequence exchange occurs between the node device and the new node device.

12. The apparatus of claim 11, wherein the processor is further configured to:
send information contained in headers of link state packets associated with all of the plurality of node devices from the particular node device to the new node device as a part of the packet sequence exchange;
receive a request from the new node device for the link state packets of one or more of the plurality of node devices;
send the link state packets to the new node device in response to receiving the request; and
update the first flooding tree and the second flooding tree to include the new node device.

13. The apparatus of claim 10, wherein the processor is further configured to initiate the packet sequence exchange when the network topology change involves a new network link being added to the network, wherein the packet sequence exchange occurs between the particular node device and one or more node devices associated with the new network link.

14. The apparatus of claim 13, wherein the processor is further configured to:
send headers of link state packets associated with all of the plurality of node devices to the one or more node devices associated with the new network link;
receive a request from the one or more of the node devices associated with the new network link for the link state packets of one or more of the plurality of node devices; and
send the link state packets to one or more of the node devices associated with the new network link in response to receiving the request.

15. The apparatus of claim 13, wherein the processor is further configured to:
determine priority information of the new network link;
update the first flooding tree to include the new network link if the priority information of the new network link indicates that the new network link has a higher priority than other network links in the first flooding tree; and
update the second flooding tree to include the new network link if the priority information of the new network link indicates that the new network link has a higher priority than other network links in the second flooding tree.

16. The apparatus of claim 10, wherein the processor is further configured to initiate the packet sequence exchange comprises initiating the packet sequence exchange that involves a complete sequence number protocol data unit exchange from the particular node device to the another node device and that involves a partial sequence number protocol data unit exchange from the another node device to the node device.

17. The apparatus of claim 10, wherein the processor is further configured to generate the first flooding tree and the second flooding tree such the first flooding tree and the second flooding tree have a maximum disjoint number of network links.

18. One or more computer readable storage media encoded with software comprising computer executable instructions and when the software is executed operable to:
generate a first flooding tree by performing a first shortest path first operation from a first selected node device in a network to a plurality of other node devices in the network;
generate a second flooding tree by performing a second shortest path first operation from a second selected node device in the network to the plurality of other node devices in the network;
detect a network topology change event in either the first flooding tree or the second flooding tree;
initiate a packet sequence exchange between a particular node device and another node device in the network in response to the detecting; and
update the first flooding tree and the second flooding tree based on information obtained during the packet sequence exchange.

19. The computer readable storage media of claim 18, wherein the instructions operable to initiate comprise instructions operable to initiate the packet sequence exchange when the network topology change event involves a new node device being added to the network, wherein the packet sequence exchange occurs between the node device and the new node device.

20. The computer readable storage media of claim 18, further comprising instructions operable to:
send information contained in headers of link state packets associated with all of the plurality of node devices from the particular node device to the new node device as a part of the packet sequence exchange;
receive a request from the new node device for the link state packets of one or more of the plurality of node devices;
send the link state packets to the new node device in response to receiving the request; and
update the first flooding tree and the second flooding tree to include the new node device.
